(19) United States
(12) Patent Application Publication
(10) Pub. No.: US 2012/0123787 A1
(43) Pub. Date: May 17, 2012

(54) AUDIOAUDIO FORMAT CONVERTING APPARATUS AND AUDIOAUDIO FORMAT CONVERTING METHOD

(75) Inventor: Daisuke Iwai, Tokyo (JP)

(73) Assignee: Kabushiki Kaisha Toshiba, Tokyo (JP)

(21) Appl. No.: 13/049,567

(22) Filed: Mar. 16, 2011

(30) Foreign Application Priority Data
Nov. 16, 2010 (JP) 2010-255987

(51) Int. Cl. G10L 19/00

(52) U.S. Cl. 704/500; 704/E19.001

(57) ABSTRACT

According to one embodiment, there is provided a audio format converting apparatus including a audio data dividing unit, first to Nth audio format converting units, and a audio data connecting unit. The audio data dividing unit creates first to Nth divided audio streams from an input audio stream, and adds the same frames as a predetermined number of frames from the head of the (i+1)th divided audio stream to the end of an i-th divided audio stream (i=1,2, to N−1). The first to Nth audio format converting units subject the first to Nth divided audio streams to audio format converting processing in parallel, so as to produce first to Nth converted audio streams. The audio data connecting unit discards the predetermined number of frames from the head of each of the second to Nth converted audio streams, and sequentially connects the first to Nth converted audio streams.

### CROSS-REFERENCE TO RELATED APPLICATIONS

This application is based upon and claims the benefit of priority from the prior Japanese Patent Application No. 2010-255987, filed on Nov. 16, 2010, the entire contents of which are incorporated herein by reference.

### FIELD

Embodiments described herein relate generally to a audio format converting apparatus and a audio format converting method.

### BACKGROUND

There have recently existed various formats (such as MP3, AAC, WMA, AC3, AMR, ADPCM, WAV, DTS, MP2, Ogg, and AVC-HD) as audio formats for reproducing music in a personal computer, a mobile phone, a portable audio player, and the like. A user selectively uses a proper one suitable for his/her uses out of these audio formats.

In the case where, for example, a motion picture is taken by a video camera, audio data included in the motion picture is normally encoded in the AC3 (i.e., Dolby Digital, Audio Code Number 3). Thereafter, when the data is transmitted to and recorded in a recording medium such as a Blu-ray disk, the data encoded in the AC3 is frequently multiplexed into an AVC-HD (i.e., Advanced Video Codec High Definition) format. Moreover, in the case where the data recorded in the recording medium is uploaded to a motion picture site, the audio data recorded in the AC3 format is often converted into an AAC (i.e., Advanced Audio Coding) or MP3 (i.e., Mpeg Audio Layer-3) format. Alternatively, in the case where data taken by a mobile phone is transmitted via the mobile phone, audio data in the AAC format is conceivably converted into an AMR (i.e., Adaptive Multi-Rate) format having a higher compression ratio.

As described above, the data in a certain audio format is frequently converted into data in another audio format according to the intended use. Consequently, there has been an increased need for improving the speed of audio format converting processing (i.e., transcoding) for converting data in a certain audio format into data in another audio format.

### BRIEF DESCRIPTION OF THE DRAWINGS

FIG. 1 is a diagram schematically illustrating the configuration of a audio format converting apparatus according to a first embodiment;

FIG. 2A is a flowchart illustrating a audio format converting method according to an embodiment;

FIG. 2B is a flowchart subsequent to the flowchart of FIG. 2A, illustrating the audio format converting method according to the embodiment;

FIG. 3(a) is a diagram illustrating an input audio stream; and FIG. 3(b) is a diagram illustrating divided audio streams A and B in the first embodiment;

FIGS. 4(a) and 4(b) are diagrams illustrating converted audio streams A and B in the first embodiment, respectively; and FIG. 4(c) is a diagram illustrating an output audio stream;

FIGS. 5(a) to 5(c) are examples of tables illustrating delay amount;

FIG. 6 is a diagram schematically illustrating the configuration of a audio format converting apparatus according to a second embodiment;

FIGS. 7(a) to 7(c) are diagrams illustrating divided audio streams A to C in the second embodiment;

FIGS. 8(a) to 8(c) are diagrams illustrating converted audio streams in the second embodiment; and FIG. 8(d) is a diagram illustrating an output audio stream;

FIGS. 9(a) to 9(c) are diagrams illustrating divided audio streams in a modification; and

FIGS. 10(a) to 10(c) are diagrams illustrating converted audio streams in the modification.

### DETAILED DESCRIPTION

According to an embodiment, there is provided a audio format converting apparatus comprising a audio data dividing unit, first to Nth audio format converting units, and a audio data connecting unit.

The audio data dividing unit creates first to Nth divided audio streams (N is an integer of 2 or more) from an input audio stream consisting of a plurality of frames. Moreover, the audio data dividing unit adds the same frames as a predetermined number of frames from the head of the (i+1)th divided audio stream to the end of an i-th divided audio stream (i is an integer from 1 to N−1) out of the first to Nth divided audio streams.

The first to Nth audio format converting units subject the first to Nth divided audio streams input from the audio data dividing unit to audio format converting processing in parallel, so as to produce first to Nth converted audio streams.

The audio data connecting unit discards the predetermined number of frames from the head of each of the second to Nth converted audio streams, and thereafter, sequentially connects the first to Nth converted audio streams to each other, so as to produce an output audio stream.

Hereinafter, descriptions will be given of two embodiments according to the present invention with reference to the drawings. Incidentally, the same reference numerals are assigned to constituent elements having the equivalent functions in the drawings, and therefore, detailed descriptions of the constituent elements having the same reference numerals will not be repeated.

### First Embodiment

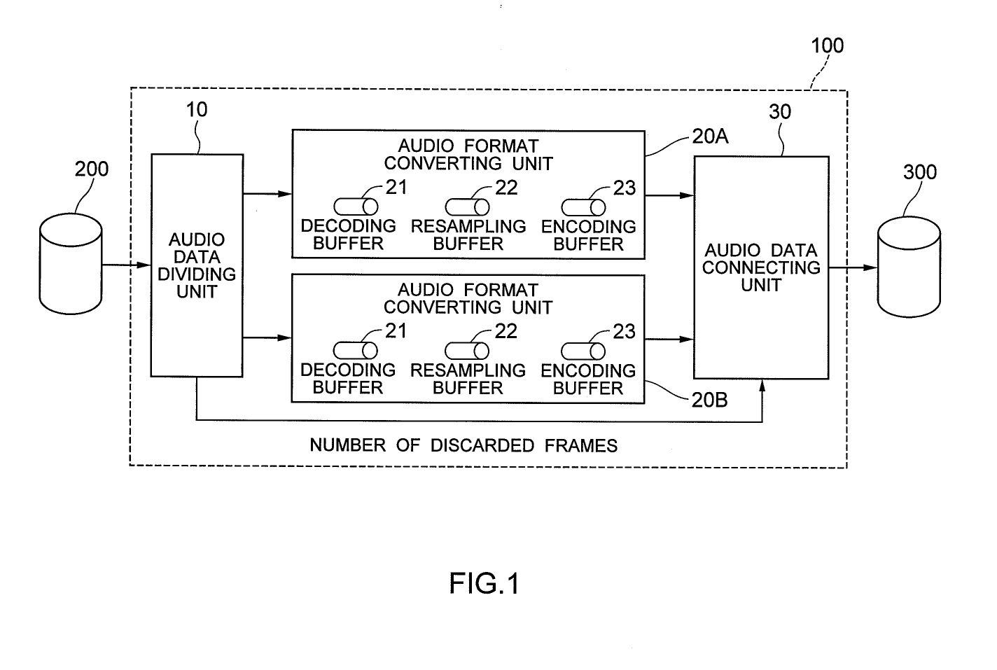

FIG. 1 is a diagram schematically illustrating the configuration of a audio format converting apparatus according to the first embodiment. A audio format converting apparatus 100 comprises a audio data dividing unit 10, a first audio format converting unit 20A, a second audio format converting unit 20B, and a audio data connecting unit 30.

Next, explanation will be made on the constituent elements of the audio format converting apparatus 100. The audio data dividing unit 10 creates a plurality of divided audio streams from an input audio stream consisting of a plurality of frames. In the first embodiment, the audio data dividing unit 10 creates a first and a second divided audio stream. In creating the divided audio stream, as for the sequential two divided audio streams, the audio data dividing unit 10 adds the same frames as a predetermined number of frames from the head of the second divided audio stream to the end of the first divided audio stream. Here, this predetermined number is determined in consideration of the total number of delay frames.

Additionally, the audio data dividing unit 10 notifies the audio data connecting unit 30 of the predetermined number as the number of frames to be discarded (i.e., the number of discarded frames) in connecting the divided audio streams.

The first and second audio format converting units 20A and 20B are disposed in different processor cores capable of processing in parallel. Each of the first and second audio format converting units 20A and 20B subjects the input divided audio stream to audio format converting processing, so as to produce a converted audio stream. Upon completion of the converting processing of the divided audio stream, each of the first and second audio format converting units 20A and 20B notifies the audio data connecting unit 30 of the completion of the converting processing, and further, outputs a converted audio stream to the audio data connecting unit 30.

The audio format converting processing includes audio decoding processing, resampling processing, and encoding processing. By the audio decoding processing, compressed audio data is decoded, to be returned to audio data in a time domain. By the resampling processing, the sampling rate of the audio data obtained by the audio decoding processing is converted. By the audio encoding processing, the resampled audio data is compressed in a designated audio format.

Each of these three processings is sequential processing requiring audio data slightly before target audio data to be processed (e.g., previous audio data by several tens ms). In view of this, the processing needs a buffer (i.e., a delay buffer), in which the past audio data by the required amount is stored. Therefore, as illustrated in FIG. 1, a delay buffer 21 for the audio decoding processing, another delay buffer 22 for the resampling processing, and a further delay buffer 23 for the audio encoding processing are included in each of the audio format converting units 20A and 20B. The size of the required delay buffer depends upon the audio decoding processing, the resampling processing, and the audio encoding processing, and further, upon processing conditions (e.g., the type of format, the sampling rate, and the like).

The audio data connecting unit 30 outputs the converted audio stream after the processing to a storage device 300. Here, the converted audio stream output from the second audio format converting unit 20B is output after the predetermined number of frames from the head are discarded. This predetermined number, that is, the number of frames to be discarded in connecting the divided audio streams to each other is equal to the number of discarded frames notified by the audio data dividing unit 10. In other words, the audio data connecting unit 30 sequentially adds the converted audio stream whose frames are discarded by the predetermined number from the head to the end of the previous converted audio stream, so as to produce an output audio stream.

Another storage device 200 stores the input audio stream therein. In contrast, the storage device 300 stores the output audio stream therein. Incidentally, the inputting and outputting storage devices 200 and 300 may not be independently provided, but may be integrated into a single storage device. Moreover, all of the input audio streams may be temporarily copied in a work memory or the like before the processing by the audio data dividing unit 10. Alternatively, in order to further increase the processing speed, every time frames in the input audio stream are read from the storage device 200, the sequentially read frames may be input into each of the audio format converting units. In this case, since the frames of discontinuous numbers are read, a randomly accessible storage device (such as a semiconductor memory, an optical disk, or a magnetic disk) needs to be used as the storage device 200.

Next, explanation will be made on the audio format converting method according to the first embodiment. Here, bit rate conversion for an audio stream in the AAC format for about 30 seconds is taken as an example. Specific conditions are as follows. The sampling rate (i.e., the sampling frequency) is 48 kHz both before and after the conversion. The number of channels is 5.1 ch before the conversion whereas 1 ch after the conversion. The bit rate of encoding is 640 kbps before the conversion whereas 48 kbps after the conversion. The sampling number is 1024 sample/frame both before and after the conversion. These conditions are input via an interface of an application by a user. Alternatively, they may be previously set based on a audio format. Incidentally, they may include the number of processor cores.

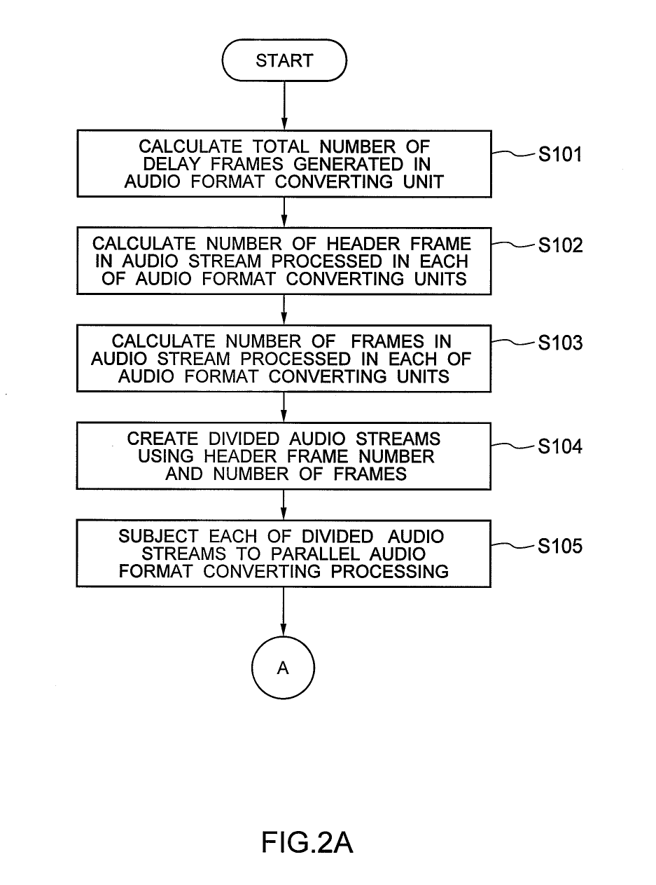

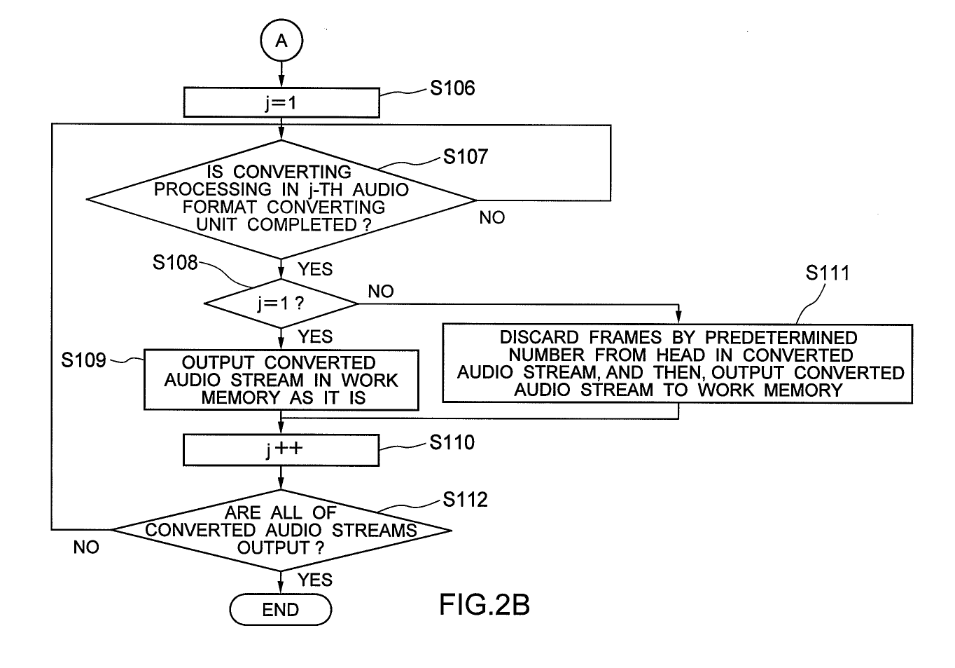

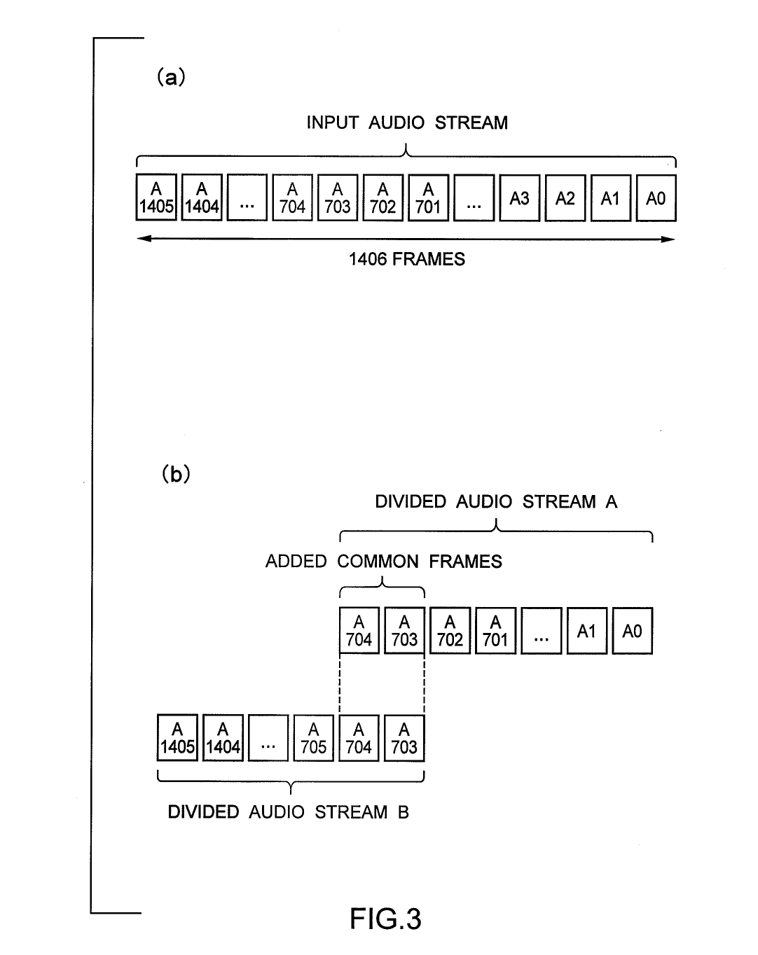

The audio format converting method in the first embodiment will be described with reference to flowcharts illustrated in FIGS. 2A and 2B. The input audio stream consists of 1406 frames A0 to A1405, as illustrated in FIG. 3(a).

The audio data dividing unit 10 calculates the total number of delay frames in the first and second audio format converting units 20A and 20B (S101). Here, the total number of delay frames is equal to the sum of the numbers of delay frames generated in the audio decoding processing, resampling processing, and audio encoding processing.

The number of delay frames in each processing under the conversion conditions is obtained by referring to a delay amount table. The delay amount table exists in each processing in the audio format converting unit. The number of delay frames required for each processing is stored under the conversion conditions. Here, the number of delay frames is obtained by rounding the size of the delay buffer up to an integer.

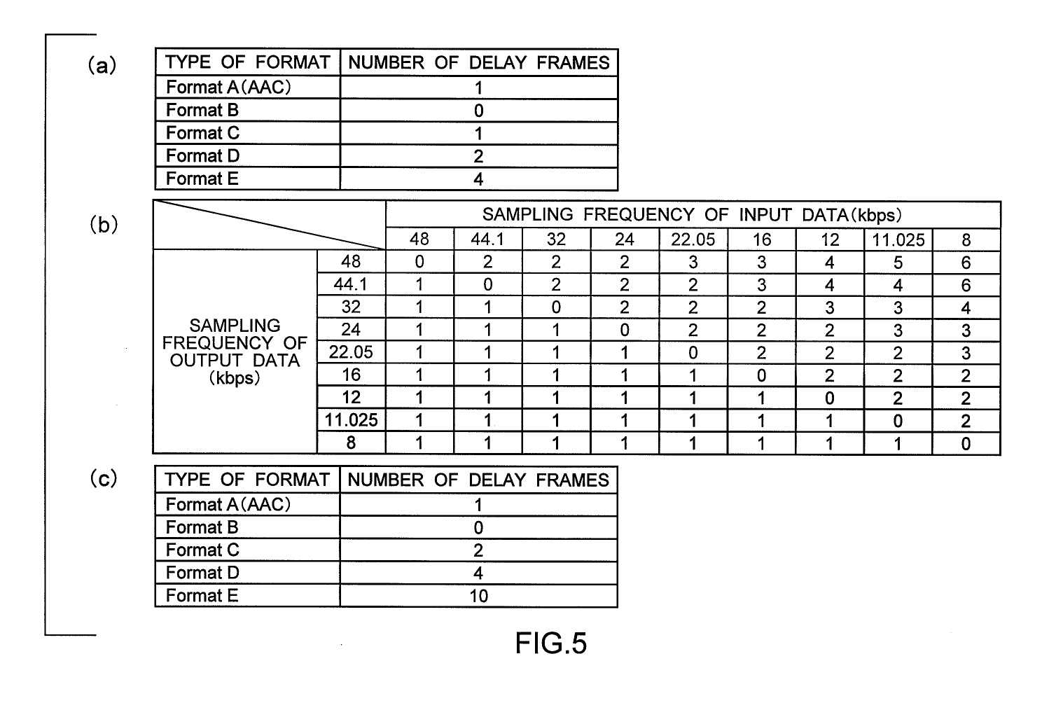

FIGS. 5(a) to 5(c) exemplify the delay amount tables. FIG. 5(a) illustrates the number of delay frames per audio format in the audio decoding processing. FIG. 5(b) illustrates the number of delay frames per input/output sampling frequency in the resampling processing. FIG. 5(c) illustrates the number of delay frames per audio format in the audio encoding processing. Incidentally, the delay amount tables may be installed in a memory or a register inside of the audio format converting apparatus 100 or a memory disposed outside of the audio format converting apparatus 100.

It is found that the number of delay frames under the above-described conditions (the input/output format: AAC; and the sampling frequency of input/output data: 48 kbps) is “1” in the audio decoding processing; “0” in the resampling processing; and “1” in the audio encoding processing. Consequently, the total number D of delay frames generated in each of the first and second audio format converting units 20A and 20B is 2.

Subsequently, the audio data dividing unit 10 calculates the number of a header frame in the divided audio stream processed in each of the first and second audio format converting units 20A and 20B (S102). The number of the header frame in the divided audio stream input into the j-th audio format converting unit is calculated by using the following equation (1):

F_{head}=Int(S/N)·(j−1)(j=1, 2, . . . , N) (1)

wherein F_{head} represents the number of the header frame; S, the number of frames in the input audio stream; and N, the number of audio format converting units. The function Int returns an integer obtained by dropping the fractional portion of the number in the case where an argument is not an integer.

Since S=1406 and N=2, the number of the header frame in the divided audio stream input into the first audio format converting unit 20A is 0. In contrast, the number of the header frame in the divided audio stream input into the second audio format converting unit 20B is 703.

Thereafter, the audio data dividing unit 10 calculates the number of frames of the divided audio stream processed in each of the first and second audio format converting units 20A and 20B (S103).

The number X1 of frames in the divided audio stream processed in the audio format converting unit other than the last unit (j=1, 2, . . . , N−1) is calculated by using the following equation (2). In addition, the number X2 of frames in the divided audio stream processed in the last unit (j=N) of the audio format converting unit is calculated by using the following equation (3).

X1=Int(S/N)+D (2)

X2=S−(N−1)·Int(S/N) (3)

Since S=1406, N=2, and D=2, the number of frames in the divided audio stream processed by the first audio format converting unit 20A is 705. In contrast, the number of frames in the divided audio stream processed by the second audio format converting unit 20B is 703.

Next, the audio data dividing unit 10 divides the input audio stream based on the calculated header frame number and number of frames, and then, creates a first divided audio stream A and a second divided audio stream B (S104). Thereafter, the audio data dividing unit 10 outputs the first divided audio stream A into the first audio format converting unit 20A and the second divided audio stream B into the second audio format converting unit 20B, respectively.

FIG. 3(b) illustrates the first divided audio stream A and the second divided audio stream B. The first divided audio stream A consists of 705 frames A0 to A704 whereas the second divided audio stream B consists of 703 frames A703 to A1405.

The first and second divided audio streams A and B include the common frames A703 and A704. In other words, the first divided audio stream A includes, at its end, the same frames as a predetermined number of frames (2 in this case) from the head of the second divided audio stream B. The common frames function as “margins.” The number of common frames corresponds to the total number of delay frames calculated in step S101.

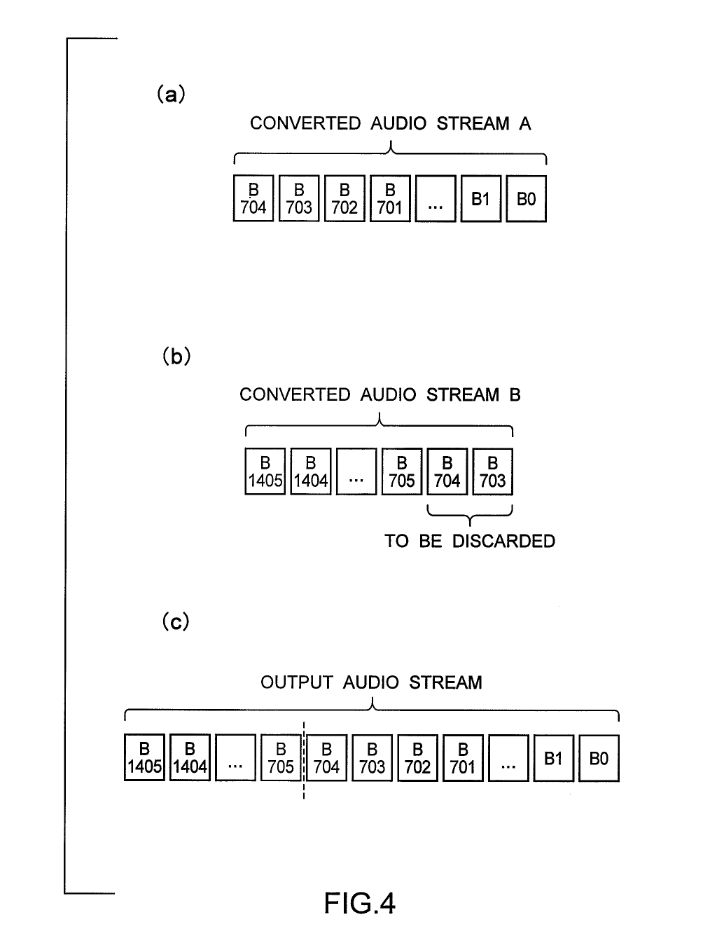

Next, the first and second audio format converting units 20A and 20B subject the divided audio streams input thereinto, respectively, to the audio format converting processing in parallel (S105). As a consequence, the audio format converting unit 20A (or 20B) produces a converted audio stream A (or B). FIG. 4(a) illustrates a converted audio stream A whereas FIG. 4(b) illustrates a converted audio stream B. It is noted that the two header frames in the converted audio stream B cannot use the past frames by the total number of delay frames during the converting processing, and therefore, they are incomplete.

Upon completion of the audio format converting processing, the first and second audio format converting units 20A and 20B notify the audio data connecting unit 30 of the completion of the converting processing, and then, output the converted audio streams A and B to the audio data connecting unit 30.

Here, the audio data connecting unit 30 sets an index j to 1 (S106). The audio data connecting unit 30 determines if the converting processing in the j-th audio format converting unit is completed (S107). The completion of the converting processing is determined based on whether or not the completion of the converting processing is received from each of the audio format converting units.

Subsequently, the audio data connecting unit 30 determines whether or not the index j is 1 (S108). If the index j is 1 (Yes in S108), the audio data connecting unit 30 stores the first converted audio stream output from the first audio format converting unit in the work memory as it is (S109). As the work memory may be used a memory disposed inside of the audio data connecting unit 30 or in the audio format converting apparatus 100.

In contrast, if the index j is not 1 (No in S108), the audio data connecting unit 30 discards the frames by the predetermined number from the head in the j-th converted audio stream output from the j-th audio format converting unit, and then, stores the j-th converted audio stream in the work memory in such a manner as to connect it to the end of the (j−1)th converted audio stream (S111). The predetermined number (i.e., the number of frames to be discarded) is equal to the total number of delay frames calculated in step S101.

The frames B0 to B704 in the first converted audio stream A output from the first audio format converting unit 20A are output to the work memory as they are. In contrast, the two header frames B703 and B704 in the second converted audio stream B output from the second audio format converting unit 20B are discarded in the audio data connecting unit 30, and then, the frames B705 to B1405 are output to the work memory.

One is added to the index j (S110). Thereafter, it is determined whether or not the converted audio streams from all of the audio format converting units are output to the work memory (S112). If the result is Yes, the converting processing comes to an end. In contrast, if the result is No, the control routine returns to S107.

In accordance with the above-described flow, the converted audio streams from all of the audio format converting units are sequentially connected to each other, thereby providing the output audio stream. FIG. 4(c) illustrates the output audio stream written in the work memory. The output audio stream is identical to a stream conventionally obtained after the audio format converting processing without dividing the input audio stream.

In another method for producing the output audio stream, the converted audio streams may be connected to each other in the storage device 300 disposed outside of the audio format converting apparatus 100. In this case, the audio data connecting unit 30 outputs the converted audio stream A to the storage device 300 without storing the converted audio stream A in the work memory whereas discards the predetermined number of frames from the head in the converted audio stream B, then output it to the storage device 300 in such a manner as to connect it to the end of the converted audio stream A.

In the first embodiment, the common frames by the number corresponding to the total number of delay frames are added to the end of the divided audio stream A in consideration of the influence of the delay buffer during the audio converting processing. When the converted audio streams A and B are connected to each other, the incomplete frames in the converted audio stream B are discarded. Consequently, it is possible to produce the output audio stream without degrading the continuity of the frames constituting the audio stream.

In this manner, the audio format converting processing is performed in parallel by using the two processor cores in the first embodiment, so that the speed of the audio format converting processing can be increased.

### Second Embodiment

Next, explanation will be made on a second embodiment. One of differences from the first embodiment resides in the number of audio format converting units. Specifically, the number of audio format converting units in the second embodiment is N. Only the differences from the first embodiment will be described below.

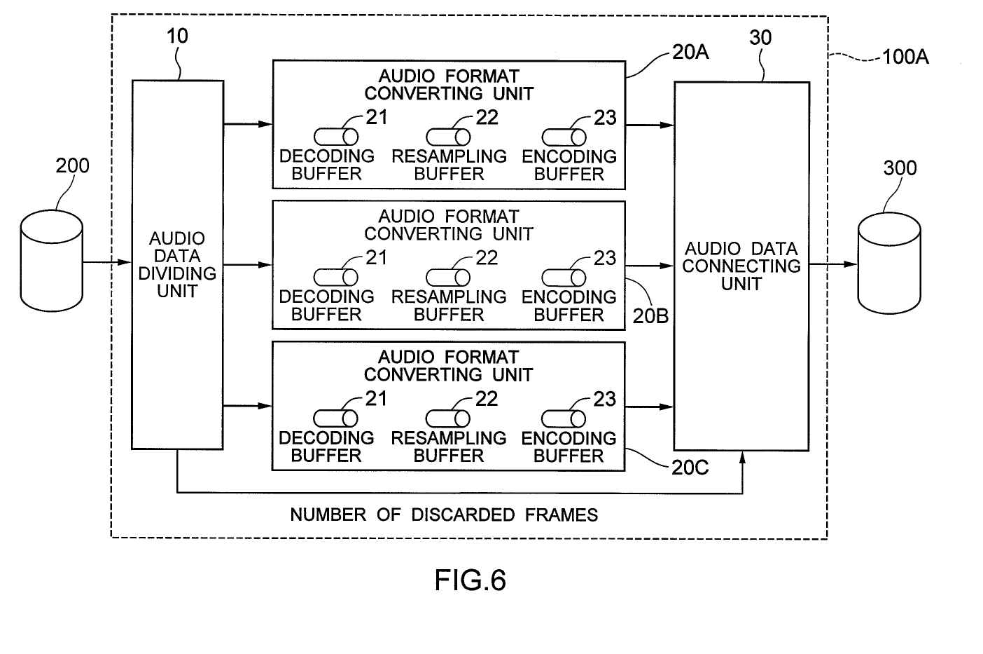

FIG. 6 is a diagram schematically illustrating the configuration of a audio format converting apparatus according to the second embodiment. A audio format converting apparatus 100A comprises a audio data dividing unit 10, first to Nth audio format converting units 20 (20A, 20B, and 20C), and a audio data connecting unit 30.

Each of the audio format converting units includes a delay buffer 21, another delay buffer 22, and a further delay buffer 23. Upon completion of converting processing of a divided audio stream, each of the audio format converting units notifies the audio data connecting unit 30 of the completion of the converting processing, and further, outputs a converted audio stream to the audio data connecting unit 30. The first to Nth audio format converting units 20A, 20B, and 20C are disposed in different processor cores capable of processing in parallel, respectively.

Next, explanation will be made on a audio format converting method according to the second embodiment. Here, bit rate conversion for an audio stream in the AAC format is taken as an example. In a specific example, the number of audio format converting units is three, and further, the configuration of an input audio stream (see FIG. 3(a)) and the conversion conditions such as a sampling rate are identical to those in the first embodiment. The audio format converting method according to the second embodiment is also performed in accordance with the flowcharts illustrated in FIGS. 2A and 2B.

First, the audio data dividing unit 10 calculates the total number of delay frames generated in each of the audio format converting units 20 (S101). Here, the total number of delay frames in each of the audio format converting units is 2 according to an input format and the conversion conditions.

Subsequently, the audio data dividing unit 10 calculates the number of the header frame in the divided audio stream input into each of the audio format converting units 20 (S102). When S=1406 and N=3, the numbers of the header frames in the divided audio streams input into the audio format converting units 20A, 20B, and 20C are 0, 468, and 936, respectively, in accordance with Equation (1).

The audio data dividing unit 10 calculates the number of frames in the divided audio stream processed in each of the audio format converting units 20 (S103). When S=1406, N=3, and D=2, the number of frames in the divided audio stream processed in each of the audio format converting units 20A, 20B, and 20C becomes 470 in accordance with Equations (2) and (3).

The audio data dividing unit 10 divides the input audio stream based on the header frame number and the number of frames, and then, creates first to Nth divided audio streams (S104). Common frames corresponding to the total number of delay frames are added to each of the ends of the first to (N−1)th divided audio streams. The audio data dividing unit 10 outputs the first to Nth divided audio streams to the first to Nth audio format converting units 20, respectively.

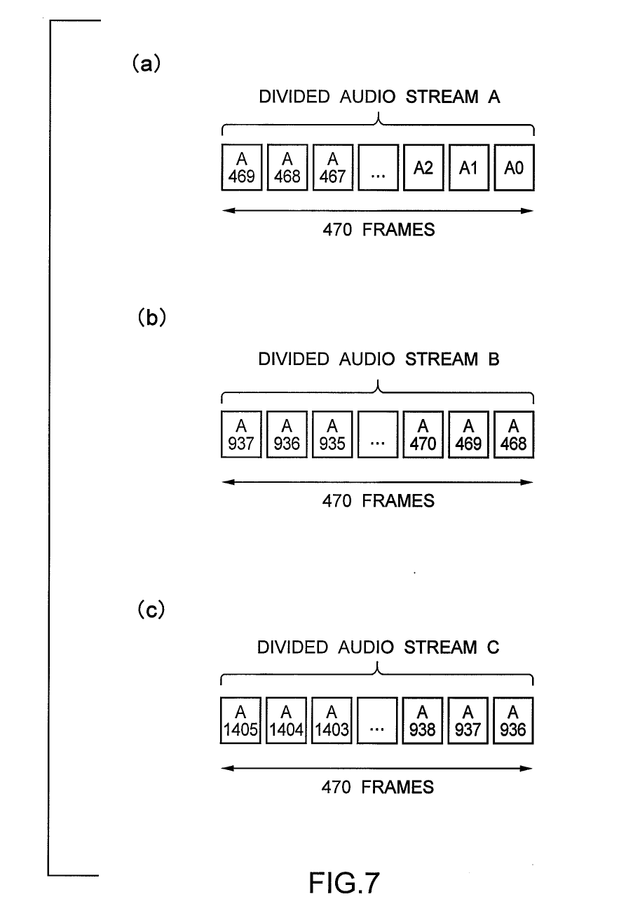

FIGS. 7(a) to 7(c) illustrate divided audio streams A, B, and C in the case where the number of audio format converting units is three. The divided audio streams A and B include the common frames (A468 and A469). In addition, the divided audio streams B and C include the common frames (A936 and A937). The number of common frames is equal to the total number of delay frames.

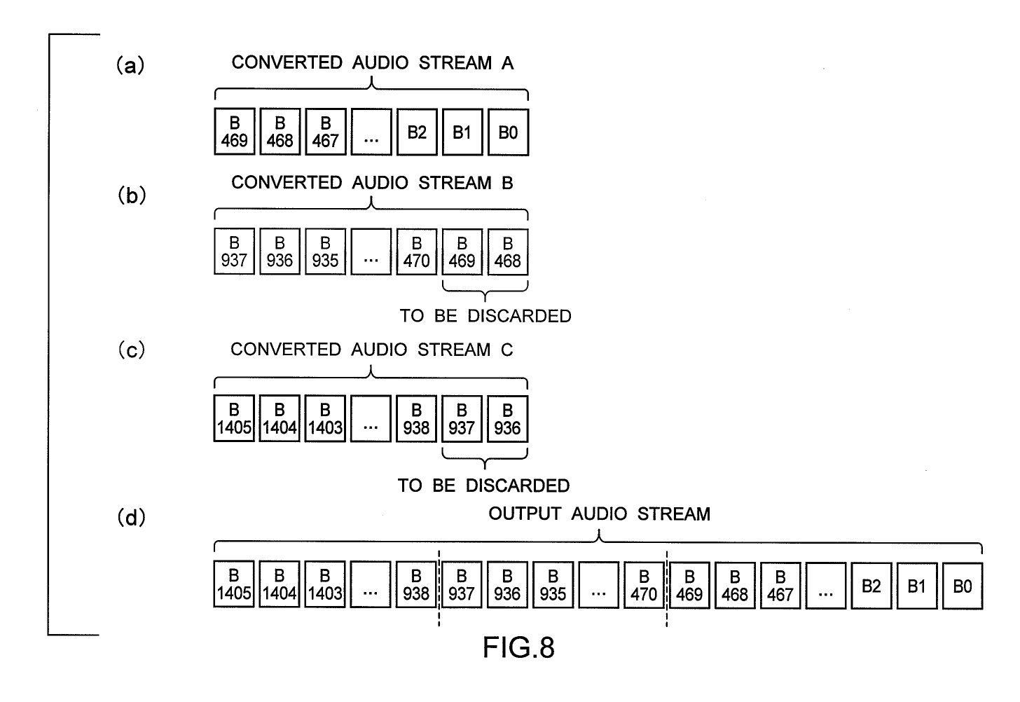

Each of the audio format converting units 20 subjects the input divided audio stream to the audio format converting processing, and then, produces a converted audio stream. FIGS. 8(a) to 8(c) illustrate the converted audio streams A, B, and C, respectively. The two header frames in each of the second to Nth converted audio streams are incomplete frames since past frames by the total number of delay frames cannot be used during the converting processing.

Thereafter, the control routine is performed in steps S106 to S110 in the same manner as in the first embodiment. The two header frames B468 and B469 in the converted audio stream B in the audio format converting unit 20B are discarded. Moreover, the two header frames B936 and B937 in the converted audio stream C in the audio format converting unit 20C are discarded. The incomplete frames are discarded in this manner, and then, the converted audio streams are connected to each other, thereby providing an output audio stream (FIG. 8(d)).

In the second embodiment, the common frames by the total number of delay frames are added to each of the ends of the first to (N−1)th divided audio streams out of the N divided audio streams, followed by the converting processing. The incomplete frames are discarded during the converting processing. Consequently, it is possible to produce the output audio stream without degrading the continuity of the frames constituting the audio stream. Additionally, the speed of the audio format converting processing can be more increased according to the second embodiment than the first embodiment.

Subsequently, a modification of the present embodiments will be described below. For example, audio of the last frame in an audio stream may be faded out by the audio format converting unit. Alternatively, in the case where the numbers of audio formats to be sampled are different from each other at the input and the output, 0 data may be embedded at a vacant portion of the last frame of a converted audio stream. In these cases, the last frame in the converted audio stream becomes incomplete, and therefore, it cannot be used in the output audio stream.

Hence, in the above-described cases, common frames are added to the end of a divided audio stream by the total number of delay frames plus one (i.e., D+1) in dividing, and then, the last frame in the converted audio stream is discarded in connecting.

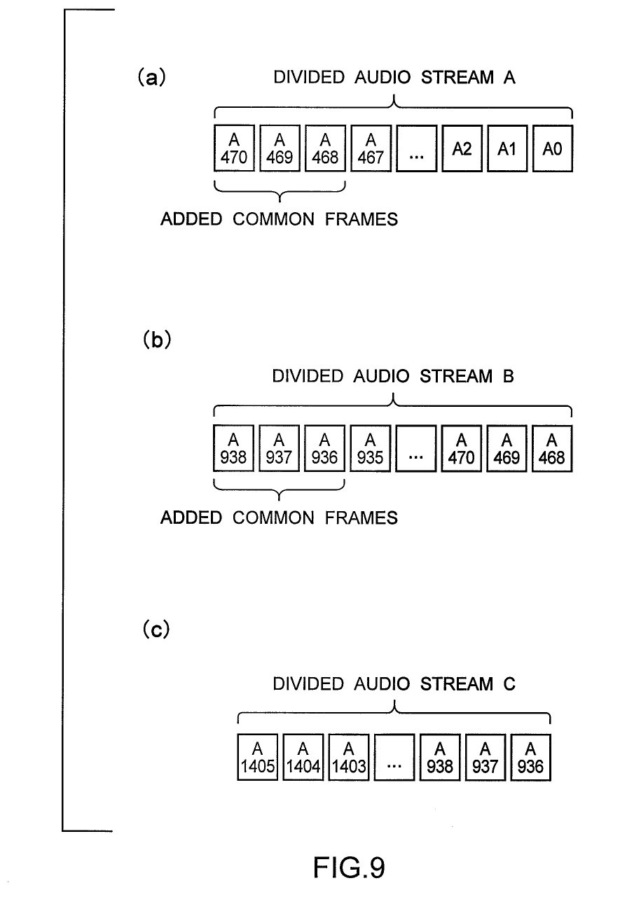

More specifically, the audio data dividing unit 10 adds common frames to each of the ends of divided audio streams A and B by the total number (two) of delay frames plus one (i.e., three), as illustrated in FIGS. 9(a) and 9(b). Here, a divided audio stream C is the same as that in the second embodiment (FIG. 9(c)). That is to say, Equation (4) is used in place of Equation (2) in order to obtain the number X1 of frames in each of the divided audio streams A and B in the present modification.

X1=Int(S/N)+(D+1) (4)

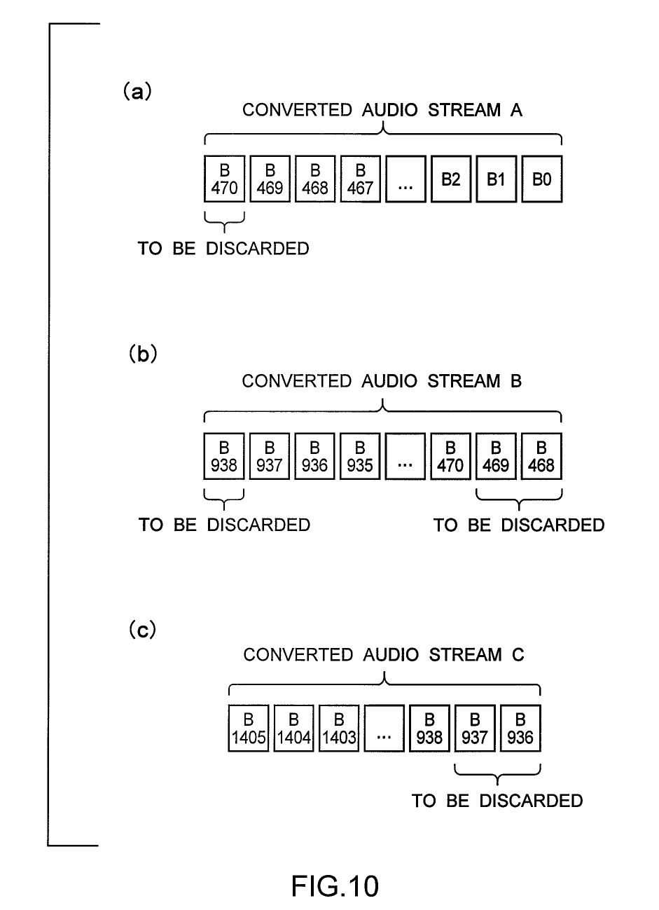

The audio data connecting unit 30 discards two frames from each of the heads of converted audio streams B and C, and further, discards the last frame in each of the converted audio streams A and B (see FIGS. 10(a) to 10(c)). According to the present modification, even if the last frames in the converted audio streams A and B become incomplete, a desired output audio stream can be produced by performing the converting processing after adding one frame.

Although the two or three processor cores are provided in the above embodiments, the present invention is not limited to such an arrangement. The number of processor cores, that is, the number of audio format converting units is arbitrary. Thus, the audio format converting processing can be scalably increased in speed according to the number of processor cores capable of the processing in parallel.

Moreover, the input audio data is not limited to compressed data, and therefore, it may be PCM data which does not require audio decoding processing.

In the above embodiments, the audio data connecting unit 30 outputs the converted audio stream to the storage device 300 in ascending order of the index j (S106 to S112). However, the present invention is not limited to such an arrangement, and converted audio streams may be output in the order in which the completion of the converting processing is received.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A audio format converting apparatus comprising:
a audio data dividing unit that creates first to Nth divided audio streams (N is an integer of 2 or more) from an input audio stream consisting of a plurality of frames, and adds the same frames as a predetermined number of frames from the head of the (i+1)th divided audio stream to the end of an i-th divided audio stream (i is an integer from 1 to N−1) out of the first to Nth divided audio streams;
first to Nth audio format converting units, each of which is capable of parallel processing, the first to Nth audio format converting units subjecting the corresponding first to Nth divided audio streams to audio format converting processing, so as to produce first to Nth converted audio streams; and
a audio data connecting unit that discards the predetermined number of frames from the head of each of the second to Nth converted audio streams, and thereafter, sequentially connects the first to Nth converted audio streams to each other, so as to produce an output audio stream.

2. The audio format converting apparatus according to claim 1, wherein the predetermined number is equal to a total number of delay frames in audio decoding processing, resampling processing, and audio encoding processing in the audio format converting unit.

3. The audio format converting apparatus according to claim 2, wherein the audio data dividing unit calculates the total number of delay frames with reference to delay amount tables storing the number of delay frames required for each processing.

4. The audio format converting apparatus according to claim 2, wherein the audio data dividing unit calculates the number F_{head} of a header frame in each of the first to Nth divided audio streams in accordance with Equation (1), calculates the number X1 of frames in each of the first to (N−1)th divided audio streams in accordance with Equation (2), and then, calculates the number X2 of frames in the Nth divided audio stream in accordance with Equation (3):
F_{head}=Int(S/N)·(j−1)(j=1, 2, . . . , N) (1)
X1=Int(S/N)+D (2)
X2=S−(N−1)·Int(S/N) (3)
wherein S represents the number of frames in the input audio stream; D denotes the total number of delay frames; and the function Int returns an integer obtained by dropping the fractional portion of the number in the case where an argument is not an integer.

5. The audio format converting apparatus according to claim 2, wherein the audio data dividing unit notifies the audio data connecting unit of the predetermined number as the number of frames to be discarded.

6. The audio format converting apparatus according to claim 2, wherein the audio format converting unit notifies the audio data connecting unit of the completion of the converting processing upon completion of the audio format converting processing.

7. The audio format converting apparatus according to claim 1, wherein the audio data dividing unit calculates the number F_{head} of a header frame in each of the first to Nth divided audio streams in accordance with Equation (1), calculates the number X1 of frames in each of the first to (N−1)th divided audio streams in accordance with Equation (2), and then, calculates the number X2 of frames in the Nth divided audio stream in accordance with Equation (3):
F_{head}=Int(S/N)·(j−1)(j=1, 2, . . . , N) (1)
X1=Int(S/N)+D (2)
X2=S−(N−1)·Int(S/N) (3)
wherein S represents the number of frames in the input audio stream; D denotes the total number of delay frames; and the function Int returns an integer obtained by dropping the fractional portion of the number in the case where an argument is not an integer.

8. The audio format converting apparatus according to claim 1, wherein the audio data dividing unit notifies the audio data connecting unit of the predetermined number as the number of frames to be discarded.

9. The audio format converting apparatus according to claim 1, wherein the audio format converting unit notifies the audio data connecting unit of the completion of the converting processing upon completion of the audio format converting processing.

10. The audio format converting apparatus according to claim 1, wherein the audio data connecting unit discards the frames by the predetermined number minus 1 from the head of each of the second to Nth converted audio streams, discards the last frame in each of the first to (N−1)th converted audio streams, and thereafter, sequentially connects the first to Nth converted audio streams so as to produce an output audio stream.

11. The audio format converting apparatus according to claim 10, wherein the predetermined number is equal to a value obtained by adding one to the total number of delay frames in each processing.

12. The audio format converting apparatus according to claim 11, wherein the audio data dividing unit calculates the total number of delay frames with reference to delay amount tables storing the number of delay frames required for each processing.

13. The audio format converting apparatus according to claim 11, wherein the audio data dividing unit calculates the number F_{head} of the header frame in each of the first to Nth divided audio streams in accordance with Equation (1), calculates the number X1 of frames in each of the first to (N−1)th divided audio streams in accordance with Equation (2), and then, calculates the number X2 of frames in the Nth divided audio stream in accordance with Equation (3):
F_{head}=Int(S/N)·(j−1)(j=1, 2, . . . , N) (1)
X1=Int(S/N)+D (2)
X2=S−(N−1)·Int(S/N) (3)
wherein S represents the number of frames in the input audio stream; D denotes the total number of delay frames; and the function Int returns an integer obtained by dropping the fractional portion of the number in the case where an argument is not an integer.

14. The audio format converting apparatus according to claim 11, wherein the audio data dividing unit notifies the audio data connecting unit of the predetermined number as the number of frames to be discarded.

15. The audio format converting apparatus according to claim 11, wherein the audio format converting unit notifies the audio data connecting unit of the completion of the converting processing upon completion of the audio format converting processing.

16. A audio format converting method comprising:
calculating a total number of delay frames in each of first to Nth audio format converting units (N is an integer of 2 or more);
calculating header frame numbers of audio streams to be subjected to audio format converting processing in each of the first to Nth audio format converting units;
creating first to Nth divided audio streams from an input audio stream based on the header frame numbers and the total number of delay frames;
subjecting the first to Nth divided audio streams to parallel audio format converting processing in the first to Nth audio format converting units, so as to produce first to Nth converted audio streams; and
discarding the frames by the total number of delay frames from the head of each of the second to Nth converted audio streams, and thereafter, sequentially connecting the first to Nth converted audio streams to each other so as to produce an output audio stream.

17. The audio format converting method according to claim 16, wherein the total number of delay frames is calculated with reference to delay amount tables storing the number of delay frames.

18. The audio format converting method according to claim 16, wherein the number F_{head} of the header frame in each of the first to Nth divided audio streams is calculated in accordance with Equation (1), the number X1 of frames in each of the first to (N−1)th divided audio streams is calculated in accordance with Equation (2), and the number X2 of frames in the Nth divided audio stream is calculated in accordance with Equation (3):
F_{head}=Int(S/N)·(j−1)(j=1, 2, . . . , N) (1)
X1=Int(S/N)+D (2)
X2=S−(N−1)·Int(S/N) (3)
wherein S represents the number of frames in the input audio stream; D denotes the total number of delay frames; and the function Int returns an integer obtained by dropping the fractional portion of the number in the case where an argument is not an integer.
